(19) United States
(12) Patent Application Publication
(10) Pub. No.: US 2025/0381725 A1
(43) Pub. Date: Dec. 18, 2025

(54) PIPE EXPANDER

(71) Applicant: Taizhou Naibo Machinery Co., Ltd., Taizhou (CN)

(72) Inventor: Huabin CHEN, Taizhou (CN)

(73) Assignee: Taizhou Naibo Machinery Co., Ltd., Taizhou (CN)

(21) Appl. No.: 18/763,945

(22) Filed: Jul. 3, 2024

(30) Foreign Application Priority Data
Jun. 17, 2024 (CN) 202410777643.0

(51) Int. Cl. B29C 57/04; B21D 41/02

(52) U.S. Cl. CPC B29C 57/045; B21D 41/02

(57) ABSTRACT

A pipe expander includes: a shell; a top shell, where the top shell is fixedly connected to a top of the shell; a conical head, where the conical head is arranged in the shell and can be extended and retracted; a ratchet mechanism, where the ratchet mechanism is sleeved on the conical head; and a deflection mechanism, where the deflection mechanism is located in the shell. The present application has the advantages of enhancing the effect of expansion and making expanding force uniform.

### CROSS-REFERENCE TO RELATED APPLICATIONS

This application claims priority to Chinese Patent Application No. 202410777643.0, filed on Jun. 17, 2024, the content of which is incorporated herein by reference in its entirety.

### TECHNICAL FIELD

The application pertains to the technical field of pipe expanding, and relates to a pipe expander, in particular to a pipe expander.

### BACKGROUND

The pipe expander is used to expand the diameter of pipes, so as to meet the requirements of different working conditions on pipes.

In practical use, it has been discovered that during pipe expanding, due to the plasticity of the pipe, there will be a certain stickiness between a pipe-expanding head die mounted on the pipe expander and the pipe. As a result, the expanding operation cannot fully act on the expanded wall, and an expanding force generated by expansion is not uniform, which affects the effect of expansion.

### SUMMARY

In view of the above problem existing in the prior art, the objective of the present application is to provide a pipe expander for enhancing the effect of expansion.

The objective of the application can be achieved by the following technical solution. A pipe expander includes:
a shell;
a top shell, where the top shell is fixedly connected to a top of the shell;
a conical head, where the conical head is arranged in the shell and can be extended and retracted;
a ratchet mechanism, where the ratchet mechanism is sleeved on the conical head and configured for the connection and mounting of a pipe-expanding head die;
a cam, where the cam is located behind the conical head and configured to push the conical head forward;
a deflection mechanism, where the deflection mechanism is located in the shell and configured to control the ratchet mechanism to defect;
a central shaft, where the central shaft is configured for the mounting of the deflection mechanism and the cam and configured to drive the deflection mechanism and the cam to rotate;
a plurality of sets of planetary gear assemblies, where the planetary gear assemblies are arranged in the shell and matched with the central shaft; and
a driving motor, where the driving motor can drive the central shaft to rotate.

In the above pipe expander, the ratchet mechanism includes a ratchet sleeve, where a peripheral wall of a front end of the ratchet sleeve is provided with an external thread, a rear end of the ratchet sleeve is provided with external teeth, and a front wall of the ratchet sleeve is provided with ratchet teeth.

In the above pipe expander, the deflection mechanism includes an indexing disc and an indexing wheel located outside the indexing disc, where a peripheral wall of the indexing wheel is provided with a plurality of deflecting blades, the indexing disc is provided with a guide groove for the deflecting blades to enter, an inclined guide plate passing through the guide groove is arranged between a top and bottom of the indexing disc, the top of the indexing disc is provided with an upper transition groove at a position corresponding to the inclined guide plate, the bottom of the indexing disc is provided with a lower transition groove at a position corresponding to the inclined guide plate, an indexing shaft is mounted in the center of the indexing wheel, and an end of the indexing shaft is provided with a planetary gear meshed with external teeth.

In the above pipe expander, an internal shell sleeve is arranged on a rear part of the ratchet mechanism.

In the above pipe expander, a spring is arranged on the conical head and between the conical head and the internal shell sleeve.

In the above pipe expander, the plurality of sets of planetary gear assemblies are arranged in a longitudinal superposition manner, each set of planetary gear assembly consists of a planetary carrier and a plurality of planetary gears meshed on the planetary carrier, and an internal gear sleeve meshed with the plurality of planetary gears is arranged in the shell.

In the above pipe expander, a bottom of the shell is provided with a connecting plate fixedly connected with the shell.

In the above pipe expander, bearings are arranged between the central shaft and the shell and between the central shaft and the top shell respectively.

In the above pipe expander, an output disc is arranged between the planetary gear assemblies and the central shaft.

Compared with the prior art, the pipe expander has the advantages of enhancing the effect of expansion and making expanding force uniform.

### BRIEF DESCRIPTION OF THE DRAWINGS

FIG. 1 is a three-dimensional diagram of a pipe expander.

FIG. 2 is a sectional view of the pipe expander.

FIG. 3 is a partial three-dimensional diagram of the pipe expander.

FIG. 4 is a partial three-dimensional diagram of the pipe expander.

FIG. 5 is a partial three-dimensional diagram of the pipe expander.

FIG. 6 is a schematic diagram of a pipe-expanding head die.

### DESCRIPTION OF THE EMBODIMENTS

The technical solution of the present application will be further described with reference to specific embodiments of the present application and the accompanying drawings, but the present application is not limited to these embodiments.

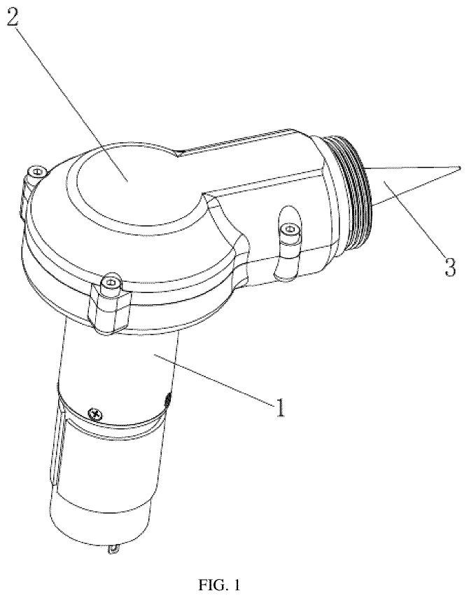

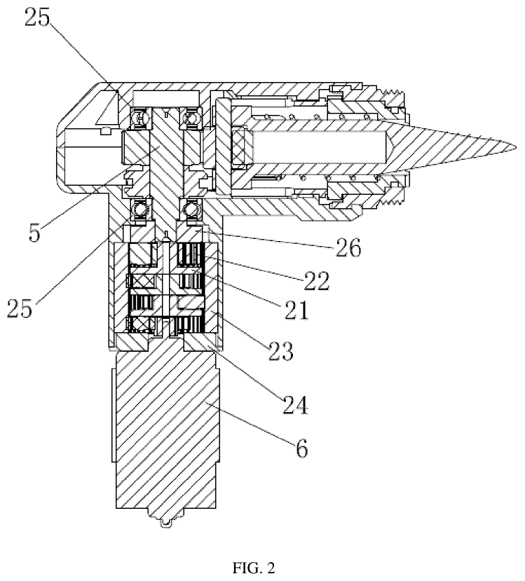

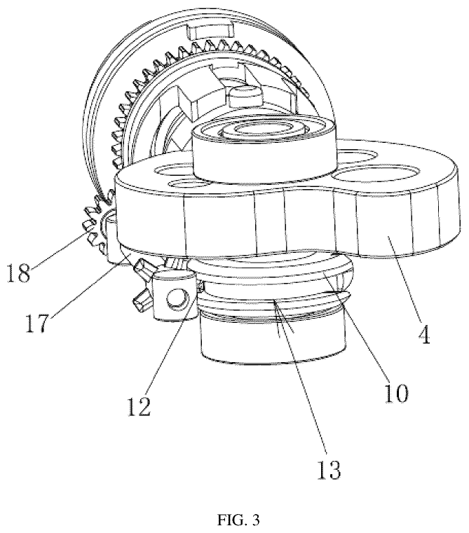

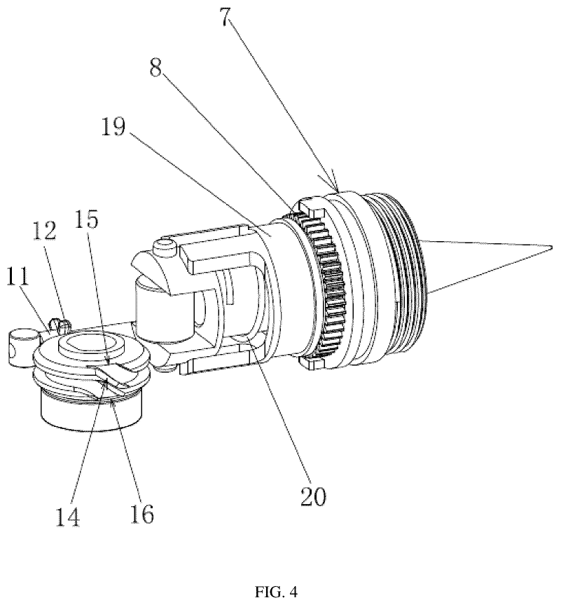

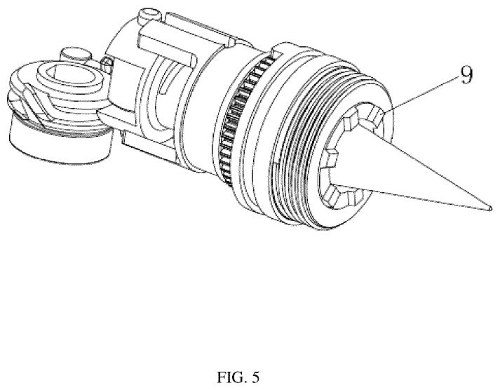

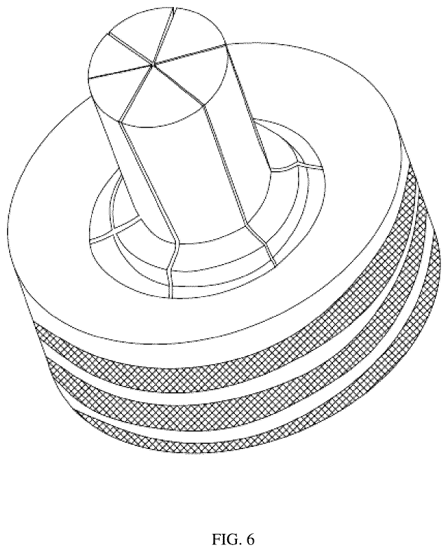

As shown in FIGS. 1-6, a pipe expander includes:
a shell 1;
a top shell 2, where the top shell is fixedly connected to a top of the shell 1;
a conical head 3, where the conical head is arranged in the shell 1 and can be extended and retracted;
a ratchet mechanism, where the ratchet mechanism is sleeved on the conical head 3 and configured for the connection and mounting of a pipe-expanding head die;
a cam 4, where the cam is located behind the conical head 3 and configured to push the conical head 3 forward;
a deflection mechanism, where the deflection mechanism is located in the shell 1 and configured to control the ratchet mechanism to defect;
a central shaft 5, where the central shaft is configured for the mounting of the deflection mechanism and the cam 4 and configured to drive the deflection mechanism and the cam 4 to rotate;
a plurality of sets of planetary gear assemblies 18, where the planetary gear assemblies are arranged in the shell 1 and matched with the central shaft 5; and
a driving motor 6, where the driving motor can drive the central shaft 5 to rotate.

More specifically, the ratchet mechanism includes a ratchet sleeve 7, where a peripheral wall of a front end of the ratchet sleeve 7 is provided with an external thread, which is connected with the pipe-expanding head die, a rear end of the ratchet sleeve 7 is provided with external teeth 8, and a front wall of the ratchet sleeve 7 is provided with ratchet teeth 9.

More specifically, the deflection mechanism includes an indexing disc 10 and an indexing wheel 11 located outside the indexing disc 10, where a peripheral wall of the indexing wheel 11 is provided with a plurality of deflecting blades 12, the indexing disc 10 is provided with a guide groove 13 for the deflecting blades 12 to enter, an inclined guide plate 14 passing through the guide groove 13 is arranged between a top and bottom of the indexing disc 10, the top of the indexing disc 10 is provided with an upper transition groove 15 at a position corresponding to the inclined guide plate 14, the bottom of the indexing disc 10 is provided with a lower transition groove 16 at a position corresponding to the inclined guide plate 14, an indexing shaft 17 is mounted in the center of the indexing wheel 11, and an end of the indexing shaft 17 is provided with a planetary gear 18 meshed with external teeth 8. The indexing disc 10 rotates and makes the corresponding deflecting blade 12 contact with the inclined guide plate 14, and the deflecting blade 12 moves toward the upward transition groove 15 along a surface of the inclined guide plate 14, so the indexing wheel 11 is driven to deflect under the action of the inclined guide plate 14. At the same time, the deflecting blade 12 adjacent to the deflecting blade 12 enters the guide groove 13 via the lower transition groove 16. The deflecting blades 12 are circulated in sequence, so that the indexing wheel 11 is deflected unit by unit, driving the planetary gear 18 at the end of the indexing shaft 17 to deflect at a corresponding angle, and ultimately, the ratchet sleeve 7 and the pipe-expanding head die are correspondingly deflected. Therefore, the pipe-expanding head die can uniformly act on the wall of the hole of a pipe, increasing the regularity of expansion and the efficiency of expansion.

Preferably, an internal shell sleeve 19 is arranged on a rear part of the ratchet mechanism.

More specifically, a spring 20 is arranged on the conical head 3 and between the conical head 3 and the internal shell sleeve 19 for restoring the conical head 3.

Preferably, the plurality of sets of planetary gear assemblies 18 are arranged in a longitudinal superposition manner, each set of planetary gear assembly 18 consists of a planetary carrier 21 and a plurality of planetary gears 22 meshed on the planetary carrier 21, and an internal gear sleeve 23 meshed with the plurality of planetary gears 22 is arranged in the shell 1.

Preferably, a bottom of the shell 1 is provided with a connecting plate 24 fixedly connected with the shell.

Preferably, bearings 25 are arranged between the central shaft 5 and the shell 1 and between the central shaft 5 and the top shell 2 respectively.

Preferably, an output disc 26 is arranged between the planetary gear assemblies 18 and the central shaft 5.

The specific embodiments described herein are only illustrative of the spirit of the present application. Those skilled in the art to which the present application pertains can make various modifications or supplements to the described specific embodiments or substitute them in similar ways without departing from the spirit of the present application or going beyond the scope defined by the appended claims.

Although the shell 1, the top shell 2, the conical head 3, the cam 4, the central shaft 5, the driving motor 6, the ratchet sleeve 7, the external tooth 8, the ratchet tooth 9, the indexing disc 10, the indexing wheel 11, the deflecting blade 12, the guide groove 13, the inclined guide plate 14, the upper transition groove 15, the lower transition groove 16, the indexing shaft 17, the planetary gear 18, the internal shell sleeve 19, the spring 20, the planetary carrier 21, the planetary gear 22, the internal gear sleeve 23, the connecting plate 24, the bearing 25, the output disc 26 and other terms are mostly used herein, the possibility of other terms is not excluded. These terms are only intended to describe and explain the essence of the present application more conveniently. It is against the spirit of the present application to construe them as any additional limitation.

What is claimed is:

1. A pipe expander, comprising:
a shell;
a top shell fixedly connected to a top of the shell;
a conical head arranged in the shell and capable of being extended and retracted;
a ratchet mechanism sleeved on the conical head and configured for connection and mounting of a pipe-expanding head die;
a cam located behind the conical head and configured to push the conical head forward;
a deflection mechanism located in the shell and configured to control the ratchet mechanism to defect;
a central shaft configured for mounting of the deflection mechanism and the cam and configured to drive the deflection mechanism and the cam to rotate;
a plurality of sets of planetary gear assemblies arranged in the shell and matched with the central shaft; and
a driving motor driving the central shaft to rotate.

2. The pipe expander according to claim 1, wherein the ratchet mechanism comprises a ratchet sleeve, a peripheral wall of a front end of the ratchet sleeve is provided with an external thread, a rear end of the ratchet sleeve is provided with external teeth, and a front wall of the ratchet sleeve is provided with ratchet teeth.

3. The pipe expander according to claim 1, wherein the deflection mechanism comprises an indexing disc and an indexing wheel located outside the indexing disc, a peripheral wall of the indexing wheel is provided with a plurality of deflecting blades, the indexing disc is provided with a guide groove for the deflecting blades to enter, an inclined guide plate passing through the guide groove is arranged between a top and bottom of the indexing disc, the top of the indexing disc is provided with an upper transition groove at a position corresponding to the inclined guide plate, the bottom of the indexing disc is provided with a lower transition groove at a position corresponding to the inclined guide plate, an indexing shaft is mounted in the center of the indexing wheel, and an end of the indexing shaft is provided with a planetary gear meshed with external teeth.

4. The pipe expander according to claim 1, wherein an internal shell sleeve is arranged on a rear part of the ratchet mechanism.

5. The pipe expander according to claim 1, wherein a spring is arranged on the conical head and between the conical head and the internal shell sleeve.

6. The pipe expander according to claim 1, wherein the plurality of sets of planetary gear assemblies are arranged in a longitudinal superposition manner, each set of planetary gear assembly consists of a planetary carrier and a plurality of planetary gears meshed on the planetary carrier, and an internal gear sleeve meshed with the plurality of planetary gears is arranged in the shell.

7. The pipe expander according to claim 1, wherein a bottom of the shell is provided with a connecting plate fixedly connected with the shell.

8. The pipe expander according to claim 1, wherein bearings are arranged between the central shaft and the shell and between the central shaft and the top shell respectively.

9. The pipe expander according to claim 1, wherein an output disc is arranged between the planetary gear assemblies and the central shaft.
